(19) United States
(12) Patent Application Publication
(10) Pub. No.: US 2025/0200380 A1
(43) Pub. Date: Jun. 19, 2025

(54) REINFORCEMENT LEARNING TO EXPLORE ENVIRONMENTS

(71) Applicant: DeepMind Technologies Limited, London (GB)

(72) Inventors: Luisa Maria Zintgraf, Oxford (GB); Zita Alexandra Magalhaes Marinho, Lisbon (PT); Iurii Kemaev, London (GB); Louis Michel Kirsch, Lugano (CH); Junhyuk Oh, London (GB); Tom Schaul, London (GB)

(21) Appl. No.: 18/846,412

(22) PCT Filed: Jun. 7, 2023
(86) PCT No.: PCT/EP2023/065306

§ 371 Date: Sep. 12, 2024

Related U.S. Application Data
(60) Provisional application No. 63/349,990, filed on Jun. 7, 2022.

(51) Int. Cl. G06N 3/092; G05B 13/02

(52) U.S. Cl. CPC G06N 3/092; G05B 13/027

(57) ABSTRACT

The invention describes the method performed by one or more computers and for training a base policy neural network that is configured to receive a base policy input comprising an observation of a state of an environment and to process the policy input to generate a base policy output that defines an action to be performed by an agent in response to the observation, the method comprising: generating training data for training the base policy neural network by controlling an agent using (i) the base policy neural network and (ii) an exploration strategy that maps, in accordance with a set of one or more parameters, base policy outputs generated by the base policy neural network to actions performed by the agent to interact with an environment, the generating comprising, at each of a plurality of time points: determining that criteria for updating the exploration strategy are satisfied at the time point; and in response to determining that the criteria are satisfied: generating a meta policy input that comprises data characterizing a performance of the base policy neural network in controlling the agent at the time point; processing the meta policy input using a meta policy to generate a meta policy output that specifies respective values for each of the set of one or more parameters that define the exploration strategy; and controlling the agent using the base policy neural network and in accordance with the exploration strategy defined by the respective values for the set of one or more parameters specified by the meta policy output.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that controls an agent interacting with an environment to perform a task in the environment.

At each time step, the system receives an input observation and selects an action from a set of actions for the agent to perform. For example, the set of actions can include a fixed number of actions or can be a continuous action space.

Generally, the system controls the agent using a base policy neural network that receives a base policy input that includes an observation and processes the base policy input to generate a base policy output that defines an action to be performed in response to the observation.

This specification describes techniques for training the base policy neural network using a meta policy that defines an exploration strategy to be used while generating training data for training the base policy neural network. The policy is described as a meta policy because it defines a policy, i.e. an exploration strategy, that is applied to a base (action selection) policy defined by the base policy neural network.

More specifically, this specification describes generating training data for training the base policy neural network by controlling the agent using (i) the base policy neural network and (ii) an exploration strategy set by a meta policy that maps, in accordance with a set of one or more parameters (referred to later as exploration strategy parameters), base policy outputs generated by the base policy neural network to actions performed by the agent to interact with the environment. For example, the base policy can be modified by the exploration strategy to define a new behavior policy that is used to select the actions performed by the agent. In some implementations the exploration strategy stochastically determines whether to use a base policy output for selecting an action to be performed by the agent or to select an action differently (according to an exploration policy). The training data may comprise tuples that each specify an observation characterizing a state of the environment, an action performed in response to the observation, and a reward received in response to the action being performed (and optionally including a next observation). Generating the training data can involve obtaining such a tuple for each of a plurality of (environment) time steps.

That is, while generating the training data, the system controls the agent using the exploration strategy instead of directly using the base policy neural network. By using the meta policy-set exploration strategy, the action performed by the agent will, at least at some time steps, be different than the “optimal” action according to the output generated by the base policy neural network. The base policy neural network can be trained, using the training data, using any reinforcement learning technique, e.g. online or offline, on-policy or off-policy. Merely as some examples a Q-learning technique or a direct or indirect policy optimization technique may be used.

Training the base policy neural network using the training data may comprise backpropagating gradients of a reinforcement learning objective function to update learnable base policy neural network parameters, e.g. weights, of the base policy neural network, e.g. using a gradient descent optimization algorithm such as Adam or another optimization algorithm.

In general, at each of a plurality of (strategy updating) time points, the technique determines whether (strategy updating) criteria are satisfied for updating the exploration strategy. If so, the exploration strategy can be updated. In implementations this involves generating a meta policy input; this comprises data characterizing a performance of the base policy neural network in controlling the agent at the time point, e.g. based on one or more rewards received by the agent.

The meta policy input is processed according to a meta policy to generate a meta policy output that specifies respective values for each of the set of one or more exploration strategy parameters that define the exploration strategy. For example the exploration strategy parameters may define a degree of stochasticity in the actions performed by the agent, e.g. a stochasticity of the new behavior policy that is used to select the actions performed by the agent. The agent can then be controlled using the base policy neural network and in accordance with the exploration strategy defined by the respective values of the (updated) exploration strategy parameter(s) specified by the meta policy output. As examples, processing the meta policy input according to the meta policy to generate the meta policy output may involve processing the meta policy input using a learned linear transformation, e.g. using a linear neural network layer, or using a (meta policy) neural network.

Particular embodiments of the subject matter described in this specification can be implemented so as to realize one or more of the following advantages.

Training the base policy neural network using the meta policy can increase the sample efficiency of observation-action pairs during the training process, e.g., decrease how many observation-action pairs need to be visited during the training process in order to reach a certain level of agent performance. Visiting observation-action pairs in an efficient way allows the base policy learning to converge more quickly with favorable performance, and is crucial for training the agent to perform favorably in many real-life, complex tasks that have a large observation-action space to sample from.

Additionally, this meta policy training technique can be used to update the exploration strategy at a much more frequent cadence than other approaches. This update flexibility enables a data-driven exploration process that can promote faster training of the base policy neural network.

Furthermore, this technique can remove the need to perform an exploration hyperparameter search, i.e., a search to find optimal values for exploration-related parameters used for generating training data in order to achieve favorable agent performance on the given task. This is beneficial as such a search is typically time and resource intensive, and, in some implementations that do not rely on simulated environments, even impractical.

Moreover, the described technique generalizes across single and multi-task domains. That is, the meta policy can be learned during training of a base policy neural network for one specific task and then used in training another base policy neural network used to control a different agent to perform a different task or to perform multiple different tasks.

The described technique is also general-purpose and can be used in scenarios where training data is being generated by one or more agents in one or more environments.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example action selection system.

FIG. 2 depicts the meta policy training subsystem and its interactions with the base policy subsystem in further detail.

FIG. 3 is a flow diagram of an example process for selecting a set of exploration strategy parameters using the meta policy training subsystem.

FIG. 4 is a block diagram of an example meta reinforcement learning training system.

FIG. 5 demonstrates performance of an agent trained with the meta reinforcement learning system compared to two other meta reinforcement learning approaches and a DQN baseline.

Like reference numbers and designations in the various drawings indicate like elements.

### DETAILED DESCRIPTION

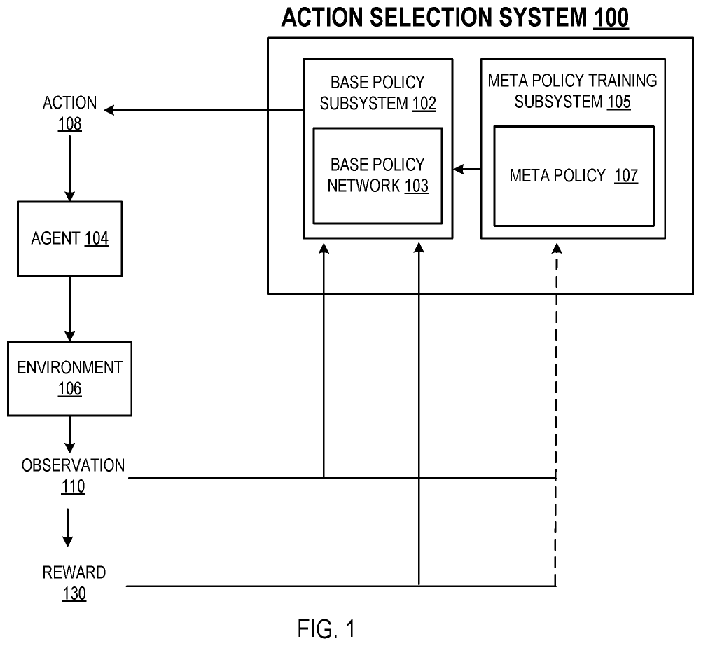

FIG. 1 shows an example action selection system 100. The action selection system 100 is an example of a system implemented as computer programs on one or more computers in one or more locations in which the systems, components, and techniques described below are implemented.

The action selection system 100 controls an agent 104 interacting with an environment 106 to accomplish a task by selecting actions 108 to be performed by the agent 104 at each of multiple (environment) time steps during the performance of an episode of the task.

As a general example, the task can include one or more of, e.g., navigating to a specified location in the environment 106, identifying a specific object in the environment 106, manipulating the specific object in a specified way, controlling items of equipment to satisfy criteria, distributing resources across devices, and so on. More generally, the task is specified by received rewards 130, i.e., such that an episodic return is maximized when the task is successfully completed. Rewards and returns will be described in more detail below. Examples of agents, tasks, and environments are also provided below.

An “episode” of a task is a sequence of interactions during which the agent 104 attempts to perform a single instance of the task starting from some starting state of the environment 106. In other words, each task episode begins with the environment 106 being in an initial state, e.g., a fixed initial state or a randomly selected initial state, and ends when the agent 104 has successfully completed the task or when some termination criterion is satisfied, e.g., the environment 106 enters a state that has been designated as a terminal state or the agent 104 performs a threshold number of actions 108 without successfully completing the task.

At each (environment) time step during any given task episode, the system 100 receives an observation 110 characterizing the current state of the environment 106 at the time step and, in response, selects an action 108 to be performed by the agent 104 at the time step. A time step at which the system selects an action 108 for the agent 104 to perform may be referred to as an environment time step. After the agent 104 performs the action 108, the environment 106 transitions into a new state and the system 100 receives both a reward 130 and a new observation 110 from the environment 106.

Generally, the reward 130 is a scalar numerical value (that may be zero) and characterizes the progress of the agent 104 towards completing the task.

As a particular example, the reward 130 can be a sparse binary reward that is zero unless the task is successfully completed as a result of the action 108 being performed, i.e., is only non-zero, e.g., equal to one, if the task is successfully completed as a result of the action 108 performed.

As another particular example, the reward 130 can be a dense reward that measures a progress of the agent 104 towards completing the task as of individual observations 110 received during the episode of attempting to perform the task, i.e., so that non-zero rewards can be and frequently are received before the task is successfully completed.

While performing any given task episode, the system 100 selects actions 108 in order to attempt to maximize a return that is received over the course of the task episode. A return refers to a cumulative measure of “rewards” received by the agent, for example, a time-discounted sum of rewards over task episodes.

That is, at each time step during the episode, the system 100 selects actions 108 that attempt to maximize the return that will be received for the remainder of the task episode starting from the time step.

Generally, at any given time step, the return that will be received is a combination of the rewards 130 that will be received at time steps that are after the given time step in the episode.

For example, at a time step t, the return can satisfy:

Σᵢγ^{i-t-1}rᵢ,

where i ranges either over all of the time steps after t in the episode or for some fixed number of time steps after t within the episode, γ is a discount factor that is greater than zero and less than or equal to one, and rᵢ is the reward at time step i.

To control the agent 108 at the first time step, the system 100 receives an observation 110 characterizing a state of the environment at the first time step.

To control the agent, at each time step in the episode, a base policy subsystem 102 of the system 100 uses a base policy neural network 103 to select the action 108 that will be performed by the agent 104 at the time step.

In particular, the base policy subsystem 102 uses the base policy neural network 103 to process the observation 110 to generate a base policy output and can then use the base policy output to select the action 108 to be performed by the agent 104 at the time step.

The base policy network 103 can generally have any appropriate neural network architecture that enables it to perform its described functions, e.g., processing an input that includes an observation 110 of the current state of the environment 106 to generate an output that characterizes an action to be performed by the agent 104 in response to the observation 110. The base policy network 103 may be a neural network system that includes multiple neural networks that cooperate to generate the output.

For example, the deep neural network can include any appropriate number of layers (e.g., 5 layers, 10 layers, or 25 layers) of any appropriate type (e.g., fully connected layers, convolutional layers, attention layers, transformer layers, recurrent layers etc.) and connected in any appropriate configuration (e.g., as a linear sequence of layers).

In one example, the base policy output may include a respective numerical probability value for each action in the fixed set of actions. The system 102 can select the action 108, e.g., by sampling an action in accordance with the probability values for the action indices, or by selecting the action with the highest probability value.

In another example, the base policy output may include a respective Q-value for each action in the fixed set of actions. The system 102 can process the Q-values (e.g., using a soft-max function) to generate a respective probability value for each action, which can be used to select the action 108 (as described earlier), or can select the action with the highest Q-value.

The Q-value for an action is an estimate of a return that would result from the agent 104 performing the action 108 in response to the current observation 110 and thereafter selecting future actions 108 performed by the agent 104 in accordance with current values of base policy neural network parameters of the base policy network 103.

As another example, when the action space is continuous, the policy output can include parameters of a probability distribution over the continuous action space and the system 102 can select the action 108 by sampling from the probability distribution or by selecting the mean action. A continuous action space is one that contains an uncountable number of actions, i.e., where each action is represented as a vector having one or more dimensions and, for each dimension, the action vector can take any value that is within the range for the dimension and the only constraint is the precision of the numerical format used by the system 100.

As yet another example, when the action space is continuous the policy output can include a regressed action, i.e., a regressed vector representing an action from the continuous space, and the system 102 can select the regressed action as the action 108.

Prior to using the base policy network 103 to control the agent 104, a meta policy training subsystem 105 within the system 100 can train the base policy network 103.

The meta policy training subsystem 105 includes a meta policy 107 that can control an exploration strategy, that maps, in accordance with a set of one or more exploration strategy parameters, base policy outputs generated by the base policy neural network 103 to actions 104 performed by the agent 104 during training.

This strategy can modify how the base policy 103 outputs are generated (e.g., by modifying the rewards 130 on which the base policy 103 is trained), how the base policy 103 outputs are used to select actions 108, or both in order to cause the agent 104 to explore the environment 110 during training.

In this way, the meta policy 107 enables the base policy network 103 to rapidly increase or decrease the stochasticity of visited observations 110 within an environment 106 as part of meta policy-controlled exploration.

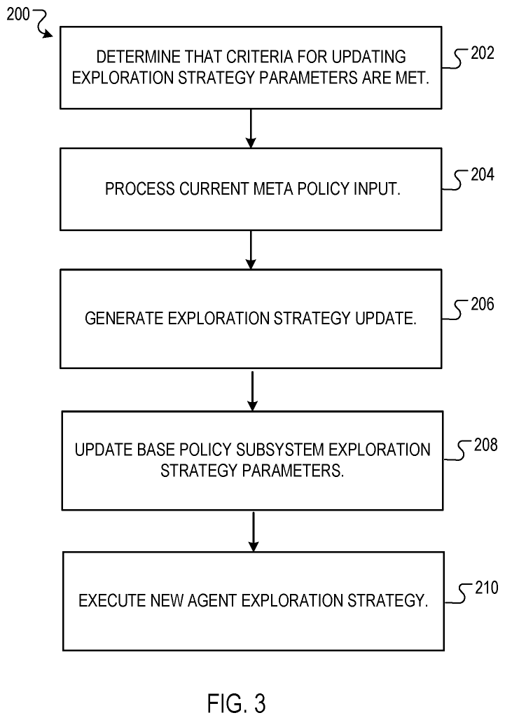

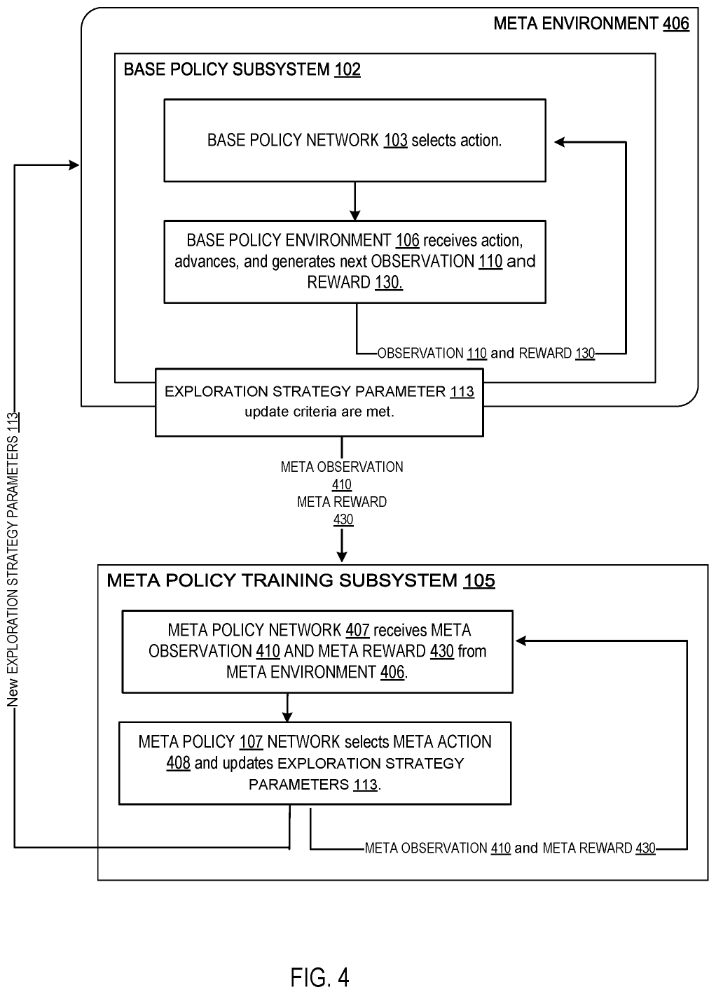

Training the base policy neural network 103 using the meta policy 107 will be described in more detail below with reference to FIGS. 3 and 4.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g., steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation, e.g., steering, and movement, e.g., braking and/or acceleration of the vehicle.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material, e.g., to remove pollutants, to generate a cleaned or recycled product. The manufacturing plant may comprise a plurality of manufacturing units such as vessels for chemical or biological substances, or machines, e.g., robots, for processing solid or other materials. The manufacturing units are configured such that an intermediate version or component of the product is moveable between the manufacturing units during manufacture of the product, e.g., via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g., minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment, e.g., between the manufacturing units or machines. In general the actions may be any actions that have an effect on the observed state of the environment, e.g., actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g., a metric of a quantity of energy, materials, or other resources, used to perform the task. In the case of a task that is to control use a resource the matric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment, e.g., sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions, e.g., a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g., data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control, e.g., cooling equipment, or air flow control or air conditioning equipment. The task may comprise a task to control, e.g., minimize, use of a resource, such as a task to control electrical power consumption, or water consumption. The agent may comprise an electronic agent configured to control operation of the items of equipment, or to control operation of the ancillary, e.g., environmental, control equipment.

In general the actions may be any actions that have an effect on the observed state of the environment, e.g., actions configured to adjust any of the sensed parameters described below. These may include actions to control, or to impose operating conditions on, the items of equipment or the ancillary control equipment, e.g., actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example in the case of a task to control, e.g., minimize, use of a resource, such as a task to control use of electrical power or water, the metric may comprise any metric of use of the resource.

In some implementations the environment is the real-world environment of a power generation facility, e.g., a renewable power generation facility such as a solar farm or wind farm. The task may comprise a control task to control power generated by the facility, e.g., to control the delivery of electrical power to a power distribution grid, e.g., to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements, e.g., to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g., an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment; fluid flow; or a physical configuration of the equipment; and observations of an electrical condition of the grid, e.g., from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In a similar way the environment may be a drug design environment such that each state is a respective state of a potential pharmaceutically active compound and the agent is a computer system for determining elements of the pharmaceutically active compound and/or a synthetic pathway for the pharmaceutically active compound. The drug/synthesis may be designed based on a reward derived from a target for the drug, for example in simulation. As another example, the agent may be a mechanical agent that performs or controls synthesis of the drug.

In some further applications, the environment is a real-world environment and the agent manages distribution of tasks across computing resources, e.g., on a mobile device and/or in a data center. In these implementations, the observations may include observations of computing resources such as compute and/or memory capacity, or Internet-accessible resources, and the actions may include assigning tasks to particular computing resources. The reward(s) may relate to one or more metrics of processing the tasks using the computing resources, e.g. metrics of usage of computational resources, bandwidth, or electrical power, or metrics of processing time, or numerical accuracy, or one or more metrics that relate to a desired load balancing between the computing resources.

As another example the environment may comprise a real-world computer system or network, the observations may comprise any observations characterizing operation of the computer system or network, the actions performed by the software agent may comprise actions to control the operation e.g. to limit or correct abnormal or undesired operation e.g. because of the presence of a virus or other security breach, and the reward(s) may comprise any metric(s) that characterizing desired operation of the computer system or network

In some applications the environment is a data packet communications network environment, and the agent is part of a router to route packets of data over the communications network. The actions may comprise data packet routing actions and the observations may comprise e.g. observations of a routing table which includes routing metrics such as a metric of routing path length, bandwidth, load, hop count, path cost, delay, maximum transmission unit (MTU), and reliability. The reward(s) may be defined in relation to one or more of the routing metrics i.e. configured to maximize one or more of the routing metrics.

As further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g., an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e., observations of a mechanical shape or of an electrical, mechanical, or electro-mechanical configuration of the entity, or observations of parameters or properties of the entity. The actions may comprise actions that modify the entity, e.g., that modify one or more of the observations. The rewards or return may comprise one or more metric of performance of the design of the entity. For example rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g., in the form of computer executable instructions for manufacturing the entity. The process may include making the entity according to the design. Thus a design an entity may be optimized, e.g., by reinforcement learning, and then the optimized design output for manufacturing the entity, e.g., as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

For example, in some implementations the described system is used in a simulation of a real-world environment to generate training data as described, i.e. using the base policy neural network and the exploration strategy, to control a simulated version of the agent to perform actions in the simulated environment, and collecting training data comprising, e.g. tuples of an observation, an action performed in response to the observation, and a reward received. The described method or system may then be deployed in the real-world environment, and used to select actions performed by the agent to interact with the environment to perform a particular task. The real-world environment, and agent, may be, e.g. any of those described above.

Optionally, in any of the above implementations, the observation at any given time step may include data from a previous time step that may be beneficial in characterizing the environment, e.g., the action performed at the previous time step, the reward received at the previous time step, or both.

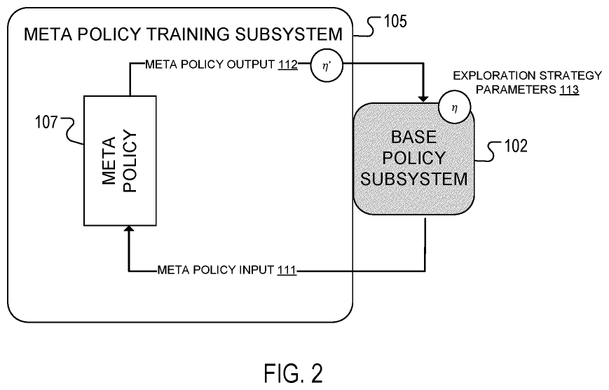

FIG. 2 depicts an example meta policy training subsystem 105 in more detail.

The base policy subsystem 102 is parameterized by η, which represents one or more exploration strategy parameters 113 that parameterize the exploration strategy within the subsystem 102.

This exploration strategy can be the application of a controlled method (i.e. an exploration method controlled by the exploration strategy parameters) to increase the stochasticity or randomness of the agent's 104 visited observation-action pairs in the environment 106.

More specifically, making use of the exploration strategy enables the subsystem 105 to perform specific, meta policy 107-controlled exploration behavior of the agent 104 within the environment 106 during the training of the base policy neural network.

The exploration strategy governs the trade-off between exploration and exploitation. This enables the meta policy 107 to guide the agent 104 to “explore” the environment 106 to obtain new information about the environment 106 rather than simply “exploiting” the current knowledge encoded in the base policy neural network 103.

In particular, by changing the parameters of the exploration strategy, the system changes the proportion of time steps at which the agent 104 explores or changes how the agent 104 explores at a given time step, i.e., how the base policy output is modified in order to select an action 108.

When strategy updating criteria for updating the exploration strategy parameters 113 are met, the base policy subsystem 102 generates a meta policy input 111 that is sent to the meta policy training subsystem 105.

As an example, these criteria for updating the exploration strategy parameters 113 can entail the same termination criteria that denote the end of a task episode. Specifically, they can correspond with the end of an episode in which the task was completed or a certain threshold number of steps were met while trying to achieve the task. In this case, the meta policy training subsystem 105 will receive the meta policy input 111 at the completion of each episode and provide a meta policy output 112 that then governs the exploration of the base policy subsystem 102 in the subsequent episode.

As another example, these criteria can prescribe an update at every N time steps within the base policy subsystem 102, wherein Nis an integer greater than or equal to 1, intermediate to the end of a task episode. That is, when Nis less than the number of steps in a task episode, the subsystem 105 can update the exploration strategy within the task episode. Updating the exploration strategy parameters 113 within each episode allows for the meta policy 107 to have finer granularity of control over the base policy exploration strategy. Other updating schedules can also be used.

The meta policy input 111 at any given time point generally includes data characterizing a performance of the base policy neural network 103 in controlling the agent 104 as of the time point using the last defined exploration strategy parameters 113. In general, the performance of the base policy neural network may be determined based on one or more rewards received by the agent.

As a particular example, the meta policy input 111 can generally include data characterizing a difference in performance of the base policy neural network 103 in controlling the agent 104 between the given chosen time point and a different (earlier) chosen time point at which the criteria for updating the parameters 113 were previously satisfied, e.g. a change in episodic return.

In certain cases, the different time point can be the previous time point such that the comparison in performance happens across an exploration parameter update 113 at time t and the most recent exploration parameter 113 update at time t−1.

The difference in performance can be defined to be a comparison between values of one or more of the same metrics at the two chosen time points.

In some examples, the meta policy input 111 can include data characterizing the observations the base policy neural network 104 experienced since the most previous exploration strategy parameter 113 update. In particular, the input 111 can include a metric related to the distribution of states visited, such as the number of environment 106 steps encountered since the last update or the agent uncertainty or entropy (e.g. a measure of an entropy of the distribution of states visited)—where the base policy output being distributed across the set of actions relatively evenly for an observation 110, e.g. in a uniform distribution, indicates a notion of high uncertainty or entropy for that observation 110, i.e. that that observation 110 has not been previously experienced by the agent 104.

In some examples, this input 111 can include data characterizing base policy neural network 103 learning progress given the most previous exploration strategy parameter 113 update, such as the base policy network 103 training loss.

In the case of a difference in performance as input 111, this example might include a subtraction of the base policy neural network 103 loss from time t−1 from the loss at time t.

In some examples, this input 111 can include data characterizing agent reward given the exploration strategy parameters 113. In particular, the input 111 can include increments in agent return throughout training.

In the case of a difference in performance as input 111, this might include a subtraction of the agent return from time t−1 from the agent return at time t.

Additionally, any of the potential inputs specified above, as well as others not mentioned, can be used either alone or in combination as part of the meta policy input 111.

Generally, the meta policy 107 is a “learned” policy.

For example, the meta policy 107 can be a learned transformation from features in a meta policy input 111 to parameters of the exploration strategy 113 or a neural network that maps the meta policy input 111 to a meta policy output 112 that updates parameters of the exploration strategy 113.

In a particular example, this learned transformation can be a linear mapping.

In other examples, this learned transformation can be a nonlinear mapping.

In a particular example, the meta policy training system 105 can jointly train the base policy network 103 and a meta policy 107, in which case both the base policy network 103 and the meta policy 107 are being updated over the course of training.

In another example, the meta policy training system 105 can train the base policy network 103 using an already trained meta policy 107. In this case, the meta policy 107 is not being updated over the course of training.

In particular, in this example, the meta policy can have been previously updated, e.g. trained, based on interactions of the agent 104 in either the same environment 106 or a different environment, or based on a different agent in either the same environment 106 or a different environment.

As will be described below in FIG. 4, the meta policy 107 can be learned using (meta) reinforcement learning, i.e., to maximize expected meta rewards that measure the performance of the base policy neural network in controlling the agent.

The system 105 processes the meta policy input 111 using the meta policy 107 to generate the meta policy output 112 that specifies updates to one or more exploration strategy parameters 113.

In some implementations, the meta policy output 112 updates the exploration strategy parameters 113 directly by including a respective updated value for each of the parameters 113.

In some other implementations, the meta policy output 112 defines the updated parameters 113 by defining an operation that performs an update to the parameters 113. As an example, the meta policy output can specify a certain change, such as a multiplication or addition of specified constants, to apply to each of the one or more of exploration strategy parameters 113.

The base policy subsystem 102 then controls the agent 104 using the base policy neural network 103 in accordance with the new exploration strategy parameters 113, to generate training data for training the base policy neural network 103. That is, the meta policy training subsystem 105 controls the agent's 104 exploration strategy through the meta policy output 112, which specifies respective values for each of the one or more parameters that define the exploration strategy parameters 113.

The base policy subsystem 102 selects actions 108 using the exploration strategy parametrized by the exploration strategy parameters 113, causes the agent 104 to perform the selected actions 108, and generates training data as a result of the interactions of the agent 104 with the environment 106.

This process repeats until a fixed number of iterations for training the base policy network 103 are met or until termination criteria for the training of the base policy network 103 are satisfied.

If training termination criteria are met, the base policy model 103 can be used to control the agent 104 directly to act with the environment 106 without applying the exploration strategy. In this case, there is no longer a need for the meta policy training subsystem 105 since exploration strategy parameters 113 are generally not used outside of the training process, i.e., because the system directly selects the “optimal” action as specified by the base policy output rather than applying an exploration strategy. Then a respective reward may, but need not be, received in response to the agent performing each of the actions.

For example, the exploration strategy parameters 113 can include any parameters that govern either the weight assigned to rewards 130 or how those rewards 130 should function within the training process; or any other parameters that can be updated over the course of training to lead to better sample efficiency or greater solvability of hard exploration tasks.

As a particular example, the exploration strategy parameters 113 can contain an F parameter that defines an epsilon-greedy exploration strategy for the base policy subsystem 102. In an epsilon-greedy exploration strategy, the subsystem 102 selects a random action with probability ε and selects an action using the base policy neural network 103 with probability 1-ε. In this case, updating F changes the probability with which the action 108 is randomly chosen instead of chosen with the base policy network 103. Thus, increasing P results in a random action being chosen more frequently, which can increase the amount of exploration being performed.

As another example, the exploration strategy parameters 113 can constitute or affect a weight applied to a count-based bonus parameter in count-based exploration, where the defined bonus reward is added to the extrinsic reward signal and is dependent on the number of times an observed environment 106 state has been visited.

As another example, the exploration strategy parameters 113 can constitute or affect a derivative metric from or impact the functioning of a reward generator that outputs a curiosity-driven intrinsic reward signal to supplement the extrinsic environment reward 130.

In yet another example, the exploration strategy parameters 113 can constitute or affect a weight applied to the incorporation of uncertainty into learning, where a strategy is parametrized through the addition of an uncertainty term to the reward signal to encourage the visiting of observations 110 with high uncertainty or entropy as part of exploration.

In another particular example, the system can maintain an ensemble of learned reward models that predict rewards given observations 110 of the environment 106. For example, the reward models can reflect human preferences of preferred observation 110-action 108 trajectories within the environment 106. In this case, the parameters 113 can define how outputs of the models in the ensembles are mapped to a final reward 130.

As a particular example, parameters 113 can define values for discrepancy thresholds that provide baselines for quantifying the reward difference between each reward model.

In a further example, these exploration strategy parameters 113 can set values that constitute the application of noise to the base policy network 103 output. In this example, the system selects the action 108 using the noisy output, the sum of the base policy network 103 output and the noise, to guide exploration.

In this case, the parameters 113 can include one or more parameters that specify how the noise is generated, such as the mean or the standard deviation of the distribution from which the noise is sampled or can be a weight applied to the noise in the sum that creates the noisy output.

Also or instead, these exploration strategy parameters 113 can specify the specific application of a softmax function σ to the base policy network 103 output (represented here by z), which converts the output to a probability for the set of actions that the system samples from to choose the action 108.

This softmax function can be temperature-dependent as defined by

$$σ ( i ) = \frac{{e}^{\frac{z ( i )}{τ}}}{{\sum }_{j} {e}^{\frac{z ( j )}{τ}}} ,$$

where z(i) is the score in the base policy output for the action i, and the sum is over the actions in the set of actions represented in the base policy output and τ is a temperature parameter. Thus, the addition of a temperature parameter τ to the arguments of the exponent in the standard softmax equation produces different probability distributions over the potential set of actions for different values of τ given the same base policy output. The temperature parameter τ can be defined by the exploration strategy parameters 113.

Additionally, any of the potential parameters specified above, as well as others not mentioned, can be used either alone or in combination as part of the exploration strategy parameters 113.

FIG. 3 is a flow diagram of an example process 200 for the meta policy training subsystem selecting the set of exploration strategy parameters that govern the base policy subsystem. For convenience, the process 200 will be described as being performed by a system of one or more computers located in one or more locations. For example, an action selection system, e.g., the action selection system 100 of FIG. 1, appropriately programmed in accordance with this specification, can perform the process 200.

The system can perform the process 200 at certain time steps during a sequence of time steps within an episode, e.g., at each time step when certain (strategy updating) criteria for updating the base policy subsystem's exploration parameters are met (step 202). In this way, the meta policy enables the base policy network to rapidly increase or decrease the stochasticity of visited states within an environment whenever the selected criteria are met.

As previously mentioned, these criteria can entail the same termination criteria that denote the end of an episode or these criteria can prescribe updates within each episode. Performing step 202 at steps intermediate to each episode allows for the meta policy to have finer granularity of control over the base policy exploration strategy.

If the criteria are not met, the system can control the agent using the current exploration strategy, i.e., without modifying the current exploration strategy.

After the determination that criteria for updating the exploration strategy parameters are met, the meta policy training subsystem receives a meta policy input (step 204). As described above, the meta policy input includes data characterizing a performance of the base policy neural network in controlling the agent at the time point.

The meta policy training subsystem processes the meta policy input using the meta policy to generate a meta policy output that generates a set of exploration strategy parameters, which parameterize an exploration strategy (step 206).

The system then updates the exploration strategy parameters in the base policy subsystem using the meta policy output (step 208).

The meta policy output either sets the exploration strategy parameters directly or defines a mathematical operation, such as an addition or multiplication of values, that performs an update to the parameters.

Updating the parameters of the exploration strategy changes the agent's exploration behavior. This new behavior is executed within the base policy environment until the next update (step 210).

FIG. 4 is a block diagram that depicts the interaction between the base policy subsystem 102 and the meta policy training subsystem 105 during an example meta reinforcement learning training process. That is, FIG. 4 is a block diagram that depicts how the meta policy 107 can be learned through meta reinforcement learning.

The prefix “meta” denotes components of a supervisory system that can exert control over the base policy subsystem 102. In this case, the meta policy 107 is tuned, i.e. trained, in accordance with a meta observation 410 and a meta reward 430 received from a meta environment 406 in response to a meta action 408. These meta observations, meta rewards, and meta actions are described below in further detail.

In the example meta reinforcement learning training process, the base policy subsystem 102 is part of a meta environment 406 that generates a meta observation 410 and meta reward 430, analogous to the observation 110 and reward 130 described above, for a meta policy 107 to learn from.

This meta policy 107 can be any learnable mapping that processes the meta policy input 111 to generate a meta policy output 112 in accordance with meta policy neural network parameters. In this case, the policy 107 is a learnable mapping that processes the meta observation 410 to generate the meta action 408.

In FIG. 4, the meta policy 107 is implemented by a meta policy network 407, with meta policy neural network parameters that are updated using reinforcement learning. For example the meta policy neural network parameters can be learned by backpropagating gradients of a reinforcement learning objective function using a gradient descent optimization algorithm such as Adam.

This meta reinforcement learning process aims to track a second order learning signal derived from the base policy subsystem 102 and to train the meta policy 107 based on agent 104 performance in the environment 106 using the meta observation 410 and meta reward 430.

In the example the base policy subsystem 102 is unchanged from FIG. 2: the base policy network 103 selects actions 108 in accordance with the meta policy-set exploration strategy parameters 113. When meta policy updating criteria are met for updating the meta policy, e.g. for training the meta policy network 407, the base policy subsystem 102 generates the meta policy input 111 for the meta policy training subsystem 105. In general, the meta policy updating criteria may be chosen from the examples previously described for the strategy updating criteria; or the meta policy updating criteria may be met after a threshold number of training steps (training the base policy neural network) have been performed since a previous time step that the meta policy 107 was updated.

The meta action 408 is an action from the meta policy training subsystem 105 that is enacted in the meta environment 406. In this case, the meta action 408 is the meta policy output 112, which is the update to the exploration parameters 113.

In particular, the meta action 408 can exert control directly upon the base policy training subsystem 102 using the update to the exploration strategy parameters 113. This meta action 408 either sets the exploration strategy parameters 113 directly or constitutes an operation that performs an update to the parameters 113 for the base policy subsystem 102.

The exploration strategy parameters 113 then govern the exploration strategy of the base policy network 103 in the base policy environment 109 within the base policy subsystem 102 until the time when the criteria to update the exploration strategy parameters 113 are met.

The meta observation 410 is an observation of the meta environment, i.e. a high-level observation of the base policy subsystem 102 that characterizes base policy observations at that time. It can be a single observation 110 taken from the most previous iteration of the base policy subsystem 102, an aggregated summary of observations, or other observation-related information that suffices to summarize the observations of the base policy network 103 since the exploration strategy parameters 113 were last updated.

The meta reward 430 is the reward of the meta environment, i.e. a summarized view of the return of the base policy subsystem 102 based on the performance of the base policy network 103 in controlling the agent 104 at that time. That is, in general the meta reward 430 may represent the performance of the base policy network 103, e.g. as previously described. It can be a single reward 130 taken from the most previous iteration of the base policy subsystem 102, an aggregated metric of rewards 130, or other return-related information that tracks the agent's 104 learning progress and suffices to summarize the base policy network 103 performance since the exploration strategy parameters 113 were last updated.

As another example, the meta reward 430 can be determined based on an aggregated metric of agent 104 rewards 130 across meta actions 408, e.g. from a one or more time series difference between an aggregated metric of agent 104 rewards 130 across meta actions 408.

For example, the meta reward 430 can be determined based on a single-time step or multi-time step difference (a difference evaluated over single or multiple time steps) between a return of the base policy neural network 103 in controlling the agent 104 at the preceding time point at which the criteria for updating the parameters 113 were satisfied and the return received at that time point.

For example, the agent 108 return received at time t corresponds with performance of the base policy network 103 operating under the most previous meta action 408, which set the exploration strategy parameters 113 at time t−1. After receiving this input 111, the meta policy 107 can generate a new meta action 408 at this time t. At the next exploration strategy parameter 113 update at time t+1, the agent 108 return received corresponds with performance of the base policy network 103 operating under the meta action 408 of time t which most recently set the exploration strategy parameters 113. A subtraction of the return from time t and t+1 can be used as the meta reward 430.

Within the meta policy training subsystem 105, the meta policy 107 can be trained to learn a mapping between the meta observation 410 and the meta action using reinforcement learning. In particular, training of the meta policy 107 can occur to update, e.g. train, the meta policy 107 using meta rewards 430 to maximize an expected time-discounted sum of meta rewards 430.

The meta policy 107 can be trained using any appropriate reinforcement learning technique, e.g., online or offline, on-policy or off-policy. Merely as one example an (advantage) actor-critic reinforcement learning technique may be used, e.g. with a value network trained using V-trace (Espeholt et al., arXiv:1802.01561).

This process of updating the meta policy 107, e.g. by training the meta policy neural network 407, repeats until a fixed M meta environment 406 time steps (each meta environment 406 time step corresponding to performance of a meta action 408), wherein M is an integer greater than or equal to 1, for training the meta policy 107 are reached, or until termination criteria for the training of meta policy 107 are met.

In particular, M represents the number of meta actions 408 input into the meta environment 406. For example, the meta policy 107 can be trained on-policy using the meta reward 430 and meta observation 410 immediately after every meta action 408.

As another example, the meta policy 107 can be trained off-policy every M meta environment steps, where M can be 5, 10, or any other appropriate number of meta steps. In this case, the meta action 408, meta observation 410, meta reward 430 for each of the intermediate meta steps can be logged in a buffer for meta policy 107 training.

In certain implementations, the meta policy 107 is implemented by a meta policy neural network 407 that has been previously updated (trained) based on meta environment 406 training data generated by base policy interactions of one or more agents in one or more environments and no longer requires updating.

In this case, the meta policy neural network 407 is used to process the meta policy input 111 to generate the meta policy output 112 specifying updates to the exploration strategy hyperparameters 113, i.e., the network 407 does not update in accordance with the meta reward 430.

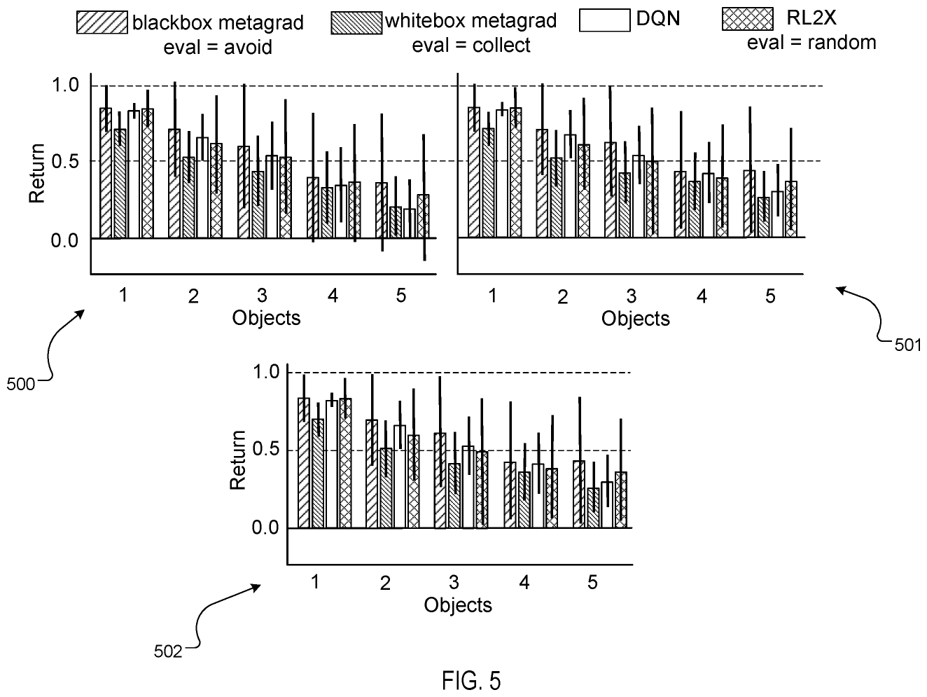

FIG. 5 shows the performance of the described meta policy training technique relative to conventional techniques for several tasks in the case of a meta reinforcement learning implementation (RL2X).

In particular, FIG. 5 shows three plots 500, 501, and 502 pertaining to setting exploration parameters ε and τ with three different techniques for a policy. Regardless of technique, each policy was trained on an avoidance task for select number of objects and tested on a variety of tasks regarding the respective number of objects.

Plot 500, 501, and 502 demonstrates the average performance in terms of average return) over 10 random seeds of “RL2X”, which is an example of a system implementing the training process described herein, when compared to agents using other approaches to predict exploration parameters, “blackbox metagradient” and “whitebox metagradient”, and one conventional reinforcement learning approach—DQN—that keeps the exploration strategy parameters at fixed values. In these plots, the DQN agent results come from static F and r parameters that were optimized using a hyperparameter search.

Plot 500 demonstrates the performance of RL2X when deploying and evaluating an agent on an in-domain avoidance task of a select number of objects as comparable to the conventional baselines.

Plots 501 and 502 demonstrate the system's translational performance as comparable to the conventional approaches on out-of-domain tasks: collection and random.

As can be seen from FIG. 5, the described techniques clearly outperform the whitebox metagradient technique on all but the random tasks (Plot 502) with 1, 4, and 5 objects and demonstrate slightly worse, but still comparable performance to the blackbox metagradient technique.

While RL2X demonstrated worse performance overall than the DQN for 9 out of the 15 total tasks included in FIG. 5, training the system did not require the resources necessary to run a hyperparameter search to find optimal exploration strategy parameters. This demonstrates a clear advantage in decreasing experimentation time when training the model.

In conclusion, performance is similar across all three meta reinforcement learning approaches. However, it is evident across Plots 500, 501, and 502, that as the number of objects increases, the average performance of RL2X decreases at a slower rate than the other benchmarked metagradient techniques.

The described techniques demonstrate the advantage of more-direct exploration over the action space and greater flexibility of updates within a single episode to the exploration strategy than the metagradient approaches allow. This advantage could result in better performance of the described techniques in shorter iterations.

Additionally, whereas the described techniques demonstrate capability for long-term credit assignment, both metagradient approaches suffer from myopia in the assignment of rewards. The described therefore tackles pre-existing issues of myopia in the meta reinforcement learning space by ensuring credit assignment between early exploration and final performance. This richer exploration can yield better performance.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers and for training a base policy neural network that is configured to receive a base policy input comprising an observation of a state of an environment and to process the policy input to generate a base policy output that defines an action to be performed by an agent in response to the observation, the method comprising:
generating training data for training the base policy neural network by controlling an agent using (i) the base policy neural network and (ii) an exploration strategy that maps, in accordance with a set of one or more parameters, base policy outputs generated by the base policy neural network to actions performed by the agent to interact with an environment, the generating comprising, at each of a plurality of time points:
determining that criteria for updating the exploration strategy are satisfied at the time point; and
in response to determining that the criteria are satisfied:
generating a meta policy input that comprises data characterizing a performance of the base policy neural network in controlling the agent at the time point;
processing the meta policy input using a meta policy to generate a meta policy output that specifies respective values for each of the set of one or more parameters that define the exploration strategy; and
controlling the agent using the base policy neural network and in accordance with the exploration strategy defined by the respective values for the set of one or more parameters specified by the meta policy output.

2. The method of claim 1, wherein the exploration strategy is an F greedy exploration strategy that selects, as an action to be performed by the agent, an action selected using a policy output generated by the base policy neural network with probability 1−ε and a random action with probability ε, and wherein the parameters that define the exploration strategy comprise one or more parameters that specify a value of ε.

3. The method of claim 1, wherein the exploration strategy applies a softmax to the policy output generated by the base policy neural network, and wherein the parameters that define the exploration strategy comprise one or more parameters that specify a temperature parameter τ for the softmax.

4. The method of claim 1, wherein the exploration strategy applies noise to the policy output generated by the base policy neural network, and wherein the parameters that define the exploration strategy comprise one or more parameters that specify how the noise is generated.

5. The method of claim 1, wherein the criteria are satisfied at every N environment time points, wherein Nis an integer greater than or equal to one.

6. The method of claim 1, wherein the criteria are satisfied after a task episode associated with a predefined task is completed, wherein the task episode is completed when the agent has successfully completed the predefined task or when a terminal state of the environment is reached.

7. The method of claim 1, wherein the operations further comprise:
in response to determining that training termination criteria are satisfied at the time point:
controlling the agent using the base policy neural network without applying the exploration strategy, comprising:
selecting actions to be performed by the agent using the base policy neural network without applying the exploration strategy, and
receiving a respective reward in response to the agent performing each of the actions.

8. The method of claim 1, wherein the data characterizing a performance of the base policy neural network in controlling the agent at the time point comprises data characterizing respective rewards received while controlling the agent using the base policy neural network.

9. The method of claim 1, wherein the meta policy input further comprises data characterizing a difference in (i) performance of the base policy neural network in controlling the agent at the time point and (ii) performance of the base policy neural network in controlling the agent at a most recent time point at which the criteria were satisfied.

10. The method of claim 1, wherein the meta policy input further comprises data identifying the time point at which the criteria are satisfied.

11. The method of claim 1, wherein the training data comprises tuples that each specify at least (i) an observation characterizing a state of the environment, (ii) an action performed in response to the observation, and (iii) a reward received in response to the action being performed.

12. The method of claim 11, further comprising:
while generating the training data, repeatedly performing training steps, wherein performing each training step comprises:
identifying one or more tuples that have been generated as of the training step; and
training the base policy neural network on the identified tuples through reinforcement learning.

13. The method of claim 1, further comprising, while generating the training data:
determining that criteria are satisfied for updating the meta policy; and,
in response:
determining a meta reward based on a performance of the base policy neural network in controlling the agent since a preceding time point at which the criteria for updating the meta policy were satisfied; and
updating the meta policy using the meta reward through reinforcement learning to maximize an expected time-discounted sum of meta rewards.

14. The method of claim 13, wherein determining that criteria are satisfied for updating the meta policy comprises:
determining that criteria are satisfied for updating the meta policy when a threshold number of training steps have been performed since a previous time step that the meta policy was updated, wherein performing each training step in the threshold number of training steps comprises:
identifying one or more tuples that have been generated as of the training step, wherein each tuple specifies at least (i) an observation characterizing a state of the environment, (ii) an action performed in response to the observation, and (iii) a reward received in response to the action being performed; and
training the base policy neural network on the identified tuples through reinforcement learning.

15. The method of claim 13, wherein the meta policy has previously been updated based on interactions of a different agent in the environment while controlled by the base policy neural network.

16. The method of claim 13, wherein the meta policy has previously been updated based on interactions of the agent in a different environment while controlled by the base policy neural network.

17. The method of claim 13, wherein the meta policy has previously been updated based on interactions of a different agent in a different environment while controlled by a different base policy neural network.

18. The method of claim 13, wherein the meta reward is a difference between (i) the performance of the base policy neural network in controlling the agent at the time step at which the criteria for updating the meta policy are satisfied and (ii) the performance of the base policy neural network in controlling the agent at a preceding time step at which the criteria for updating the meta policy were satisfied.

19. The method of claim 18, wherein the performance is measured based on rewards received in response to actions performed by the agent.

20. The method of claim 1, wherein the meta policy has been learned through reinforcement learning based on meta rewards.

21. The method of claim 20, wherein the meta rewards include meta rewards computed from performance of one or more agents in one or more environments while controlled by one or more different base policy neural networks.

22. (canceled)

23. The method of claim 1, wherein the agent is a mechanical agent and the environment is a real-world environment.

24. The method of claim 23, wherein the agent is a robot.

25. The method of claim 1, wherein the environment is a real-world environment of a service facility comprising a plurality of items of electronic equipment and the agent is an electronic agent configured to control operation of the service facility.

26. The method of claim 1, wherein the environment is a real-world manufacturing environment for manufacturing a product and the agent comprises an electronic agent configured to control a manufacturing unit or a machine that operates to manufacture the product.

27. The method of claim 1, wherein the environment is a simulated environment and the agent is a simulated agent.

28. The method of claim 27, further comprising:
after the training, deploying the base policy neural network for use in controlling a real-world agent interacting with a real-world environment.

29. The method of claim 27, further comprising:
after the training, controlling a real-world agent interacting with a real-world environment using the base policy neural network.

30. A system comprising:
one or more computers; and
one or more storage devices communicatively coupled to the one or more computers, wherein the one or more storage devices store instructions that, when executed by the one or more computers, cause the one or more computers to perform operations comprising:
generating training data for training the base policy neural network by controlling an agent using (i) the base policy neural network and (ii) an exploration strategy that maps, in accordance with a set of one or more parameters, base policy outputs generated by the base policy neural network to actions performed by the agent to interact with an environment, the generating comprising, at each of a plurality of time points:
determining that criteria for updating the exploration strategy are satisfied at the time point; and
in response to determining that the criteria are satisfied:
generating a meta policy input that comprises data characterizing a performance of the base policy neural network in controlling the agent at the time point;
processing the meta policy input using a meta policy to generate a meta policy output that specifies respective values for each of the set of one or more parameters that define the exploration strategy; and
controlling the agent using the base policy neural network and in accordance with the exploration strategy defined by the respective values for the set of one or more parameters specified by the meta policy output.

31. One or more non-transitory computer storage media storing instructions that when executed by one or more computers cause the one or more computers to perform operations comprising:
generating training data for training the base policy neural network by controlling an agent using (i) the base policy neural network and (ii) an exploration strategy that maps, in accordance with a set of one or more parameters, base policy outputs generated by the base policy neural network to actions performed by the agent to interact with an environment, the generating comprising, at each of a plurality of time points:
determining that criteria for updating the exploration strategy are satisfied at the time point; and
in response to determining that the criteria are satisfied:
generating a meta policy input that comprises data characterizing a performance of the base policy neural network in controlling the agent at the time point;
processing the meta policy input using a meta policy to generate a meta policy output that specifies respective values for each of the set of one or more parameters that define the exploration strategy; and
controlling the agent using the base policy neural network and in accordance with the exploration strategy defined by the respective values for the set of one or more parameters specified by the meta policy output.
